(19) United States
(12) Patent Application Publication
(10) Pub. No.: US 2026/0210828 A1
(43) Pub. Date: Jul. 23, 2026

(54) DETECTION DEVICE

(71) Applicant: Japan Display Inc., Tokyo (JP)

(72) Inventors: Daichi ABE, Tokyo (JP); Kaoru ITO, Tokyo (JP)

(21) Appl. No.: 19/357,342

(22) Filed: Oct. 14, 2025

(30) Foreign Application Priority Data
Oct. 16, 2024 (JP) 2024-180494

(51) Int. Cl. G01N 15/01; G01N 15/06

(52) U.S. Cl. CPC G01N 15/01; G01N 15/06

(57) ABSTRACT

A detection device includes a light source, a planar optical sensor with optical sensors, an object placement portion allowing an object to be detected to be placed such that the object to be detected is interposed between the light source and the planar optical sensor, and a processor. The object to be detected is a culture medium accommodated in a dish. The planar optical sensor is configured to output data reflecting an intensity of light emitted from the light source and reaching the optical sensors. The processor is configured to perform: an extraction process to extract a boundary line in the data corresponding to an edge of the dish; and a determination process to determine formation of a colony on the culture medium by comparing the data obtained at different times. In the determination process, outputs of the optical sensors reflected outside the boundary line are excluded from the data.

### CROSS-REFERENCE TO RELATED APPLICATION

This application claims the benefit of priority from Japanese Patent Application No. 2024-180494 filed on Oct. 16, 2024, the entire contents of which are incorporated herein by reference.

### BACKGROUND

### 1. Technical Field

What is disclosed herein relates to a detection device.

### 2. Description of the Related Art

Devices are known that acquire an image by imaging a Petri dish in which a culture medium (e.g., agar) for culturing cultivation targets such as bacteria is formed, and detect colonies of the cultivation targets formed on the culture medium from the image (for example, Japanese Patent Application Laid-open Publication No. 2012-080802).

In processes related to the detection of colonies, measures are taken to maintain a more favorable environment for the cultivation targets, to suppress the spoilage of the culture medium, and the like. As part of such measures, the Petri dish may be placed under an environment that is relatively cooler than ambient air. As a result, dew condensation may occur on the Petri dish. The dew condensation on the Petri dish may produce shadows on the image obtained by imaging the Petri dish. The shadows on the image caused by the dew condensation may be difficult to be distinguished from shadows on the image caused by the colonies. Therefore, the condensed dew can be confused with the colonies and may decrease the accuracy of detection of the colonies.

For the foregoing reasons, there is a need for a detection device that can more accurately detect colonies.

### SUMMARY

According to an aspect, a detection device includes: a light source configured to emit light; a planar optical sensor in which a plurality of optical sensors configured to detect the light from the light source are two-dimensionally arranged; an object placement portion provided to allow an object to be detected to be placed such that the object to be detected is interposed between the light source and the planar optical sensor; and a processor configured to control operations of the light source and the planar optical sensor and perform processes based on outputs of the optical sensors. The object to be detected is a culture medium accommodated in a dish of a container. The planar optical sensor is configured to output data reflecting an intensity of light emitted from the light source and reaching the optical sensors through the object to be detected. The processor is configured to perform: an extraction process to extract a circumferential outline in the data corresponding to an edge of the dish, as a boundary line; and a determination process to determine whether a colony has been formed on the culture medium based on a comparison between a plurality of pieces of the data obtained at different times. In the determination process, outputs of the optical sensors reflected outside the boundary line are excluded from each of the pieces of the data.

### BRIEF DESCRIPTION OF THE DRAWINGS

FIG. 1 is a diagram illustrating a main configuration of a detection device;

FIG. 2 is a diagram illustrating a configuration example of a detection area and a wiring area;

FIG. 3 is a circuit diagram illustrating a circuit configuration of an optical sensor;

FIG. 4 illustrates schematic views illustrating configuration examples of a light source;

FIG. 5 is a schematic diagram schematically illustrating a configuration example of a detection system;

FIG. 6 is a schematic diagram illustrating a relation between one detection device and an external configuration;

FIG. 7 is a schematic view illustrating the main configuration of the detection device and structures of components including an object to be detected that is placed on the detection device;

FIG. 8 is a schematic plan view illustrating a case where the object to be detected, placed on a light-transmitting member, is viewed from a planar optical sensor side;

FIG. 9 is a schematic plan view illustrating an exemplary case where colonies are formed in a culture medium;

FIG. 10 is a schematic plan view illustrating an exemplary case where water droplets are formed on the object to be detected;

FIG. 11 is a diagram explaining an overview of the Hough transform;

FIG. 12 is a diagram illustrating a plurality of exemplary circumferences obtained by the Hough transform;

FIG. 13 is a diagram illustrating an x-y coordinate system where the inside of a circle is distinguished from the outside thereof;

FIG. 14 is a schematic diagram illustrating an exemplary application of a mask process to a plurality of optical sensors arranged in the detection area;

FIG. 15 is a flowchart of processing related to operations of the detection device;

FIG. 16 is a flowchart of an initial process; and

FIG. 17 is a flowchart of a periodic operation.

### DETAILED DESCRIPTION

The following describes an embodiment of the present disclosure with reference to the drawings. What is disclosed herein is merely an example, and the present disclosure naturally encompasses appropriate modifications easily conceivable by those skilled in the art while maintaining the gist of the present invention. To further clarify the description, the drawings may schematically illustrate, for example, widths, thicknesses, and shapes of various parts as compared with actual aspects thereof. However, they are merely examples, and interpretation of the present disclosure is not limited thereto. The same element as that illustrated in a drawing that has already been discussed is denoted by the same reference numeral through the description and the drawings, and detailed description thereof may not be repeated where appropriate.

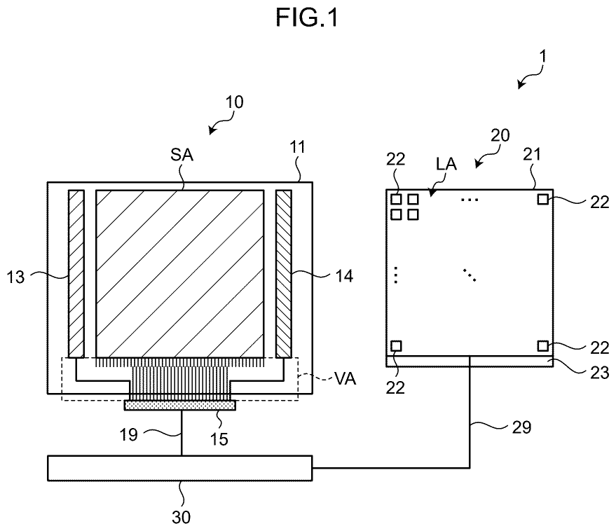

FIG. 1 is a diagram illustrating a main configuration of a detection device 1. The detection device 1 includes a planar optical sensor 10, a light source panel 20, and a control circuit 30. The planar optical sensor 10 and the light source panel 20 of the detection device 1 are coupled to the control circuit 30.

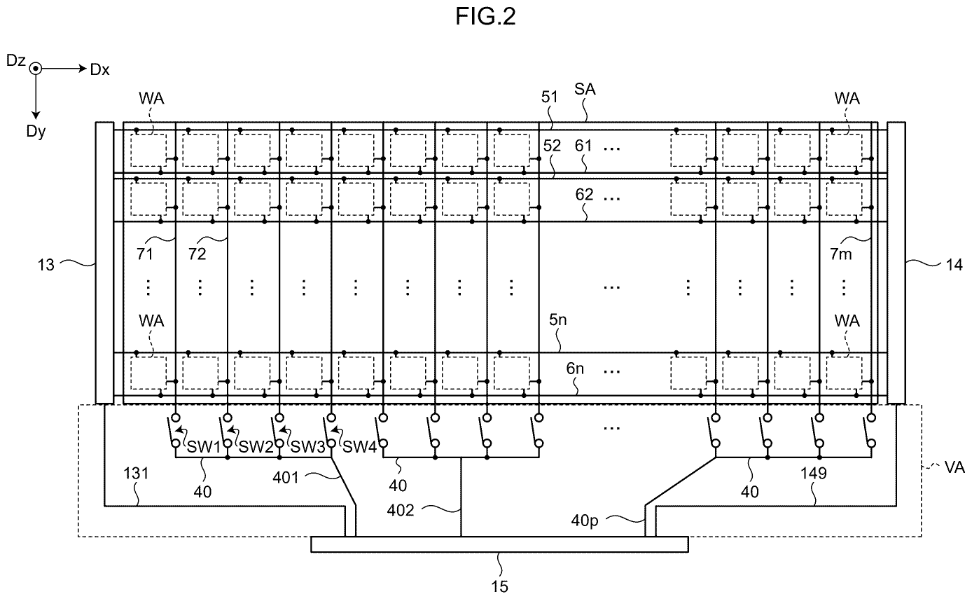

The planar optical sensor 10 is provided with a detection area SA (refer to FIG. 2) on a substrate 11. A reset circuit 13, a scan circuit 14, and a wiring area VA are provided on the substrate 11. Components on the detection area SA, the reset circuit 13, and the scan circuit 14 are coupled to a detection circuit 15 via the wiring area VA.

The light source panel 20 has a light-emitting area LA that emits light to the detection area SA. The light source panel 20 is provided with a light source 22 on a substrate 21. The light source 22 emits light. Specifically, the light source 22 includes a light-emitting element such as a light-emitting diode (LED) and is provided in the light-emitting area LA. In the example illustrated in FIG. 1, a plurality of the light sources 22 are arranged in a matrix having a row-column configuration on the substrate 21.

The light source panel 20 is provided with a light source drive circuit 23. Under the control of the control circuit 30, the light source drive circuit 23 controls turning on and off of each of the light sources 22 and the luminance thereof when being turned on. The light sources 22 may be provided so as to be individually controllable in light emission or may be provided so as to emit light all together.

The control circuit 30 performs various types of control related to the operation of the detection device 1. Specifically, the control circuit 30 is a circuit, such as a field-programmable gate array (FPGA) that can implement a plurality of functions. The control circuit 30 may have other configurations, such as an application-specific integrated circuit (ASIC). The control circuit 30 is coupled to the light source drive circuit 23 via wiring 29 and performs processing related to the lighting of the light sources 22, such as determination of lighting patterns and lighting timing of the light sources 22.

The control circuit 30 is coupled to the detection circuit 15 via wiring 19 and obtains an output from the detection circuit 15. The control circuit 30 also controls the timing of obtaining the output from the detection circuit 15, that is, the timing of operating the scan circuit 14 so as to provide a gate signal to a scan line 6. Thus, the control circuit 30 controls operations of the light sources 22 and the planar optical sensor 10. The control circuit 30 further performs processes based on outputs of a plurality of optical sensors WA. Such processes include various types of processes, such as an outline extraction process and the Hough transform, which are to be described later. Such processes also include a determination process to determine whether a colony has been formed. Such a process will be described later.

Although not illustrated in the drawings, the detection device 1 includes an analog-to-digital conversion circuit, a digital-to-analog conversion circuit, and other components. The analog-to-digital conversion circuit is a circuit for allowing the outputs from the optical sensors WA (refer to FIG. 2) transmitted via the detection circuit 15 to be handled in arithmetic processing by the control circuit 30. The digital-to-analog conversion circuit is a circuit for allowing digital signals generated by the arithmetic processing of the control circuit 30 to be used for controlling the operations of the planar optical sensor 10 and the light source panel 20. These circuits may be included, for example, in part or in whole in the detection circuit 15. These circuits may alternatively be functions performed by circuits mounted on flexible printed circuits (FPCs) provided as the wiring 19 and the wiring 29. These circuits may alternatively be mounted in other ways on the detection device 1.

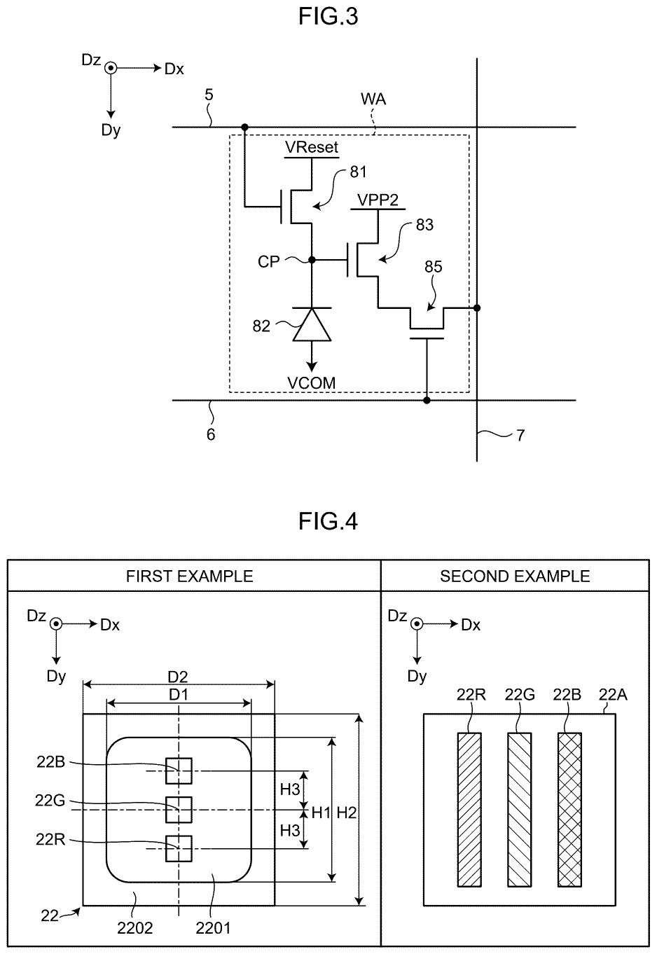

FIG. 2 is a diagram illustrating a configuration example of the detection area SA and the wiring area VA. A plurality of the optical sensors WA (FIG. 3) are two-dimensionally arranged in the detection area SA of the planar optical sensor 10. In the embodiment, as illustrated in FIG. 2, the optical sensors WA are arranged in a matrix having a row-column configuration along a first direction Dx and a second direction Dy. The first direction Dx is orthogonal to the second direction Dy. In the following description, the term “third direction Dz” refers to a direction orthogonal to the first direction Dx and the second direction Dy.

The reset circuit 13 is coupled to reset signal transmission lines 51, 52, . . . , 5n. Hereinafter, the term “reset signal transmission line 5” refers to any one of the reset signal transmission lines 51, 52, . . . , 5n. The reset signal transmission line 5 is wiring along the first direction Dx. In the example illustrated in FIG. 2, n reset signal transmission lines 5 are arranged in the second direction Dy. n is a natural number equal to or larger than 2. The n reset signal transmission lines 5 are each coupled, at one end in the first direction Dx, to the reset circuit 13.

The scan circuit 14 is coupled to scan lines 61, 62, . . . , 6n. Hereinafter, the term “scan line 6” refers to any one of the scan lines 61, 62, . . . , 6n. The scan line 6 is wiring along the first direction Dx. In the example illustrated in FIG. 2, n scan lines 6 are arranged in the second direction Dy. The n scan lines 6 are each coupled, at the other end in the first direction Dx, to the scan circuit 14.

As illustrated in FIG. 2, the reset signal transmission lines 5 and the scan lines 6 are alternately arranged in the second direction Dy in the detection area SA. The reset circuit 13 and the scan circuit 14 illustrated in FIGS. 1 and 2 are arranged at locations facing each other with the detection area SA interposed therebetween, but the layout of the reset circuit 13 and the scan circuit 14 is not limited to this layout and can be changed as appropriate.

Signal lines 71, 72, . . . , 7m are also provided in the detection area SA. Hereinafter, the term “signal line 7” refers to any one of the signal lines 71, 72, . . . , 7m. The signal line 7 is wiring along the second direction Dy.

In the example illustrated in FIG. 2, m signal lines 7 are arranged in the first direction Dx. m is a natural number equal to or larger than 2. The m signal lines 7 are each coupled, at one end in the second direction Dy, to one of a plurality of switches (for example, a switch SW1, a switch SW2, a switch SW3, or a switch SW4) included in a multiplexer 40.

The multiplexer 40 is provided in the wiring area VA. The multiplexer 40 includes a plurality of switches. In the example illustrated in FIG. 2, the switches SW1, SW2, SW3, and SW4 are illustrated as the switches. The switches included in one multiplexer 40 are turned on (conducting state) at different times from one another. During a period when one of the switches included in one multiplexer 40 is on (conducting state), the other switches are off (non-conducting state). The number of the multiplexers 40 corresponds to the number (m) of the signal lines 7. When the number of the switches is p, m/p is sufficient as the number of the multiplexers 40. When more than one multiplexer 40 are provided, each of the multiplexers 40 is coupled to the detection circuit 15 via an individual one of wiring lines 401, 402, . . . , 40p.

The coupling between the signal lines 7 and the detection circuit 15 via the multiplexer 40 is merely exemplary and is not limited to this example. The signal lines 7 may be individually directly coupled to the detection circuit 15 in the wiring area VA. In the wiring area VA, the reset circuit 13 is coupled to the detection circuit 15 via wiring 131. In the wiring area VA, the scan circuit 14 is coupled to the detection circuit 15 via wiring 149.

In the detection of light by a photodiode (PD) 82 (refer to FIG. 3) provided in the optical sensor WA, the detection circuit 15 outputs signals to control operation timing of the reset circuit 13 and the scan circuit 14 under the control of the control circuit 30. The detection circuit 15 receives the outputs from the optical sensors WA. The detection circuit 15 converts the signals received from the optical sensors WA into data that can be interpreted by the control circuit 30 and outputs the data to the control circuit 30. The detection circuit 15 of the embodiment is a microcontroller unit (MCU).

FIG. 3 is a circuit diagram illustrating a circuit configuration of the optical sensor WA. The first direction Dx and the second direction Dy in FIG. 3 merely correspond to the directions of the reset signal transmission lines 5, the scan lines 6, and the signal lines 7, and do not exactly indicate the relative positional relation of the circuit configuration in the optical sensor WA.

As illustrated in FIG. 3, a switching element 81, the PD 82, a transistor element 83, and a switching element 85 are provided in the optical sensor WA. The PD 82 is a photodiode (PD). The switching elements 81 and 85 and the transistor element are metal-oxide semiconductor field-effect transistors (MOSFETs).

The gate of the switching element 81 is coupled to the reset signal transmission line 5. One of the source and the drain of the switching element 81 is supplied with a reset potential VReset. The other of the source and the drain of the switching element 81 is coupled to the cathode of the PD 82 and the gate of transistor element 83. Hereinafter, the term “coupling part CP” refers to a point where the other of the source and the drain of the switching element 81 is coupled to the cathode of the PD 82 and the gate of transistor element 83. A reference potential VCOM is supplied from the anode side of the PD 82. The potential difference between the reset potential VReset and the reference potential VCOM is set in advance, but the reset potential VReset and the reference potential VCOM may be variable. The reset potential VReset is higher than the reference potential VCOM.

The drain of the transistor element 83 serving as a source follower is supplied with an output source potential VPP2. The source of the transistor element 83 is coupled to one of the source and the drain of the switching element 85. The other of the source and the drain of the switching element 85 is coupled to the signal line 7. The gate of the switching element 85 is coupled to the scan line 6.

The reset potential VReset, the reference potential VCOM, and the output source potential VPP2 are supplied by the detection circuit 15 to the optical sensor WA based on, for example, electric power supplied via a power supply circuit (not illustrated) coupled to the detection circuit 15. The output form of these potentials is not limited to this form, and can be changed as appropriate.

The output source potential VPP2 is set in advance. The potential on the source side of the transistor element 83 is a potential lower than the output potential of the PD 82 by a voltage (Vth) between the gate and the source of the transistor element 83. In this case, the potential on the source side of the transistor element 83 corresponds to the reset potential VReset and the reference potential VCOM. The potential of the output of the PD 82 corresponds to photovoltaic power generated by the PD 82 in response to the light detected by the PD 82 during an exposure period.

When the gate of the switching element 85 is turned on by the gate signal supplied from the scan circuit 14 via the scan line 6, the source and the drain of the switching element 85 are brought into a conducting state therebetween. This operation transmits, to the signal line 7 via the switching element 85, a signal (potential) transmitted via the transistor element 83 to the switching element 85. Thus, the output from the optical sensor WA is generated. Hereinafter, the term “gate signal” refers to the signal (potential) supplied from the scan circuit 14 via the scan line 6. The scan circuit 14 is a circuit that outputs the gate signal. As described with reference to FIGS. 2 and 3, the optical sensors WA coupled to the scan lines 6 and the signal lines 7 are arranged in a matrix having a row-column configuration in the detection area SA of the planar optical sensor 10. The scan line 6 is provided along the first direction Dx and is configured to transmit the gate signal that causes the optical sensors WA to generate the outputs. The signal line 7 is configured to transmit the outputs of the optical sensors WA along the second direction Dy.

The output of one PD 82 provided in one optical sensor WA corresponds to the intensity of the light detected by the PD 82 during the exposure period set in advance. The output of the PD 82 is reset in response to a signal supplied by the reset circuit 13 via the reset signal transmission line 5. When the signal turns on the gate of the switching element 81, the source and the drain of the switching element 81 are brought into a conducting state therebetween. This operation resets the potential of the coupling part CP to the reset potential VReset.

FIG. 4 illustrates schematic views illustrating configuration examples of the light source 22. As illustrated in FIG. 4, the light source 22 includes a first light source 22R, a second light source 22G, and a third light source 22B. The first light source 22R, the second light source 22G, and the third light source 22B emit light in different colors from one another. In the embodiment, the first light source 22R emits red (R) light. The second light source 22G emits green (G) light. The third light source 22B emits blue (B) light.

As illustrated as “First Example” in FIG. 4, the light source 22 has, for example, a light-emitting area 2201 and a frame area 2202. In the light-emitting area 2201, the first light source 22R, the second light source 22G, and the third light source 22B are arranged along the second direction Dy as viewed from a planar viewpoint. The frame area 2202 is a frame-like area surrounding the light-emitting area 2201. A width D1 in the first direction Dx of the light-emitting area 2201 is smaller than a width D2 in the first direction Dx of the frame area 2202. A height H1 in the second direction Dy of the light-emitting area 2201 is smaller than a height H2 in the second direction Dy of the frame area 2202. The distance between the first light source 22R and the second light source 22G is a distance H3. The distance between the second light source 22G and the third light source 22B is also the distance H3. The distance H3 is less than half the height H1. In “First Example” in FIG. 4, the width D1 is equal to the height H1, and the width D2 is equal to the height H2, but at least one of the widths may differ from a corresponding one of the heights. The light source 22 may be replaced with a light source of another form, specifically, such as a light source 22A illustrated in “Second Example” in FIG. 4. In the light source 22A, the longitudinal directions of the first light source 22R, the second light source 22G, and the third light source 22B are along the second direction Dy, and the first light source 22R, the second light source 22G, and the third light source 22B are arranged in this order from one side toward the other side in the first direction Dx. First Example and Second Example in FIG. 4 are exemplary forms of the light source according to the present disclosure, which is not limited to these examples. The shape of the first light source 22R, the second light source 22G, and the third light source 22B as viewed from a planar viewpoint and the positional relation between the first light source 22R, the second light source 22G, and the third light source 22B can be changed as appropriate. The term “planar viewpoint” refers to a viewpoint from which a plane along the first direction Dx and the second direction Dy (Dx-Dy plane) is squarely viewed.

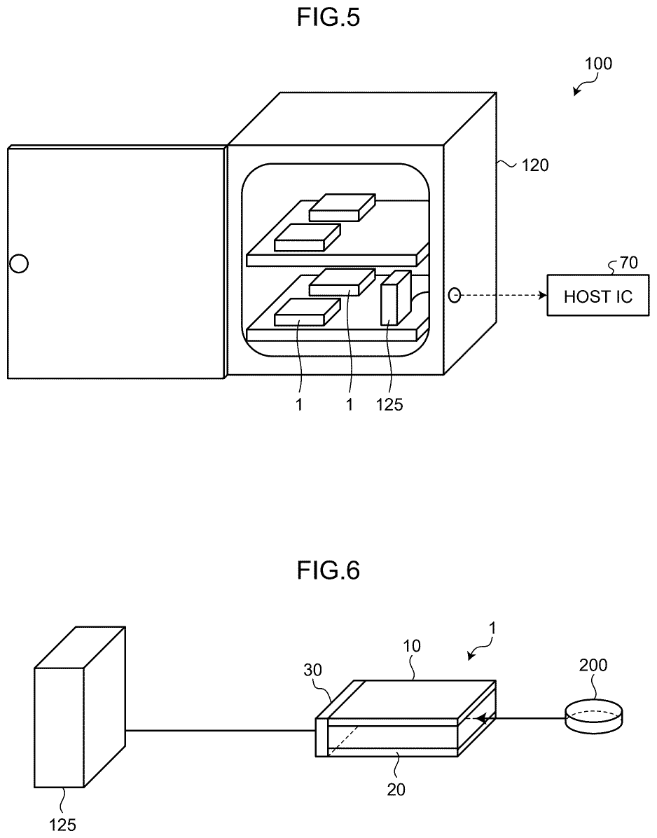

FIG. 5 is a schematic diagram schematically illustrating a configuration example of a detection system 100 including the detection device 1. As illustrated in FIG. 5, the detection system 100 includes a plurality of the detection devices 1, a host integrated circuit (IC) 70, and a coupling circuit 125. The detection devices 1 are electrically coupled to the common host IC 70 via the coupling circuit 125.

An incubator 120 illustrated in FIG. 5 is maintained such that an environment (temperature, humidity, and the like) therein is suitable for cultivation at an object to be detected 200 while a door is closed. The detection devices 1 are placed in the incubator 120.

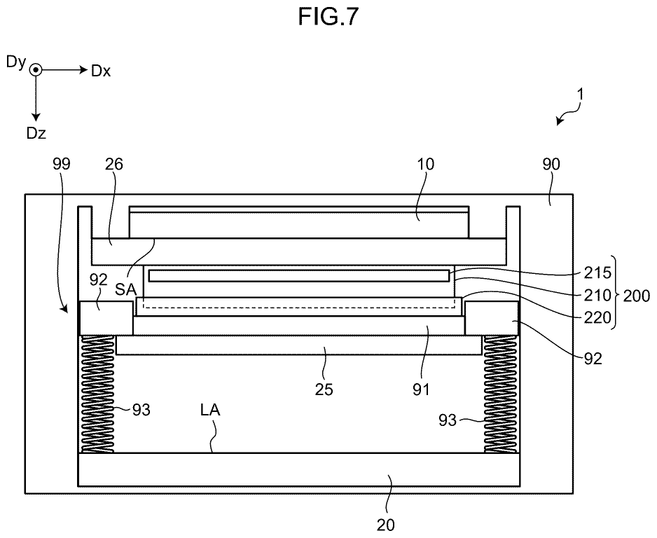

FIG. 6 is a schematic diagram illustrating a relation between one of the detection devices 1 and an external configuration. As illustrated in FIG. 6, the detection device 1 is coupled to the coupling circuit 125 by coupling the control circuit 30 to the coupling circuit 125. As illustrated in FIG. 6 and FIG. 7, which is to be described later, the planar optical sensor 10 faces the light source panel 20. The object to be detected 200 can be placed between the planar optical sensor 10 and the light source panel 20.

FIG. 6 only schematically illustrates a rough relation between the planar optical sensor 10, the light source panel 20, and the object to be detected 200. A specific structure for placing the object to be detected 200 between the planar optical sensor 10 and the light source panel 20 will be described with reference to FIG. 7.

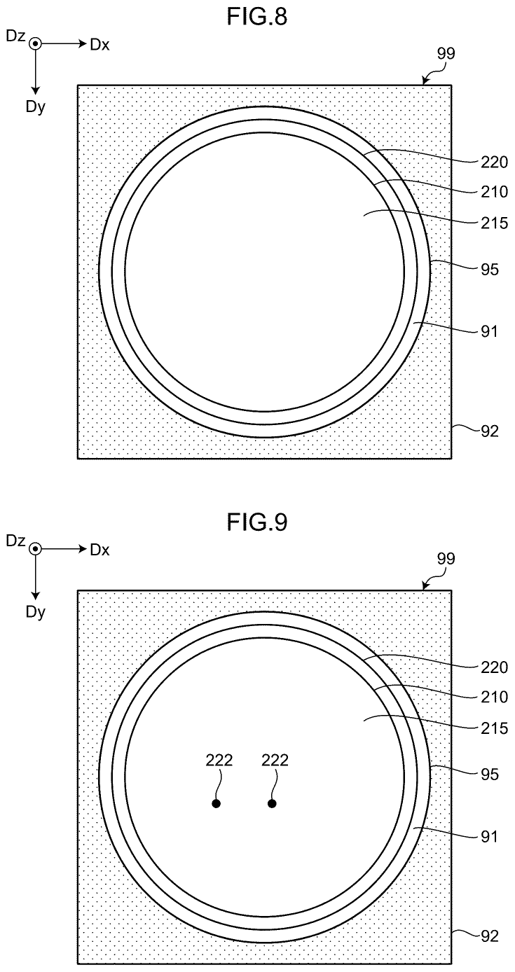

FIG. 7 is a schematic view illustrating the main configuration of the detection device 1 and structures of components including the object to be detected 200 placed on the detection device 1. The object to be detected 200 is a culture medium 215 (e.g., agar) accommodated in a dish 210 of a container. The container further includes a lid 220. The dish 210 is specifically a Petri dish. The lid 220 is a cover of the dish 210. As illustrated in FIG. 8 and other drawings to be explained later, the inner diameter of the annular sidewall of the lid 220 is equal to or more than the outer diameter of the annular sidewall of the dish 210. That is, the lid 220 has a cylindrical outer circumferential wall that covers the cylindrical outer circumferential wall of the dish 210 from the outside. The culture medium 215 is a culture medium capable of culturing colonies. Hereinafter, the term simply called “colony” refers to a colony of cultivation targets cultured on the culture medium 215 formed on the object to be detected 200. The cultivation targets are, for example, biological tissues or microorganisms, which are assumed to be cultured on the culture medium 215. The culture medium 215 has a light-transmitting property with its degree of light transmission varying depending on the presence or absence of the colony and the thickness of the colony. The object to be detected 200 is placed on a light-transmitting member 91. The light-transmitting member 91 is a plate-like member made of colorless glass or a light-transmitting colorless synthetic resin.

FIG. 8 is a schematic plan view illustrating a case where the object to be detected 200, placed on the light-transmitting member 91, is viewed from the planar optical sensor 10 side. As illustrated in FIG. 8, the light-transmitting member 91 is a circular member having a diameter that can accommodate therein the object to be detected 200 as viewed from a planar viewpoint. The light-transmitting member 91 has a light-transmitting area that can accommodate therein the object to be detected 200 between the planar optical sensor 10 and the light source panel 20. The light-transmitting member 91 is in contact with a light-blocking member 92 at the outer peripheral edge. The light-blocking member 92 is a plate-like member into which the light-transmitting member 91 is fitted. The light-blocking member 92 has a light-blocking property.

An edge 95 illustrated in FIG. 8 is the outer peripheral edge of the light-transmitting member 91 and is the inner peripheral edge of the light-blocking member 92 into which the light-transmitting member 91 is fitted. The edge 95 is circular as viewed from a planar viewpoint. A light-transmitting area may be formed inside the edge 95 by overlapping a light-transmitting member serving as the light-transmitting member 91 with the light-blocking member 92 hollowed out in a circular shape so as to form an inner peripheral edge corresponding to the edge 95. In this case, the light-transmitting member 91 need not have a circular disc shape.

In the embodiment, a diffusion plate 25 is provided on the light source panel 20 side of the light-transmitting member 91. The diffusion plate 25 is an optical component that diffuses light. The diffusion plate 25 is located to be interposed between the light-transmitting member 91 and the light-emitting area LA of the light source panel 20. When the diffusion plate 25 receives the light emitted from the light-emitting area LA from the light source panel 20 side, the diffusion plate 25 further diffuses the direction of traveling of the light as the light is transmitted toward the light-transmitting member 91. This diffusion can uniform, as viewed from a planar viewpoint, the light from the light-emitting area LA formed by a set of the light sources 22 that are two-dimensionally arranged.

As illustrated in FIG. 7, in the embodiment, an elastic member 93 is provided between the light-blocking member 92 and the light source panel 20. The elastic member 93 has elasticity to urge the light-blocking member 92 toward the planar optical sensor 10. Specifically, the elastic member 93 is a cylindrical compression coil spring, as illustrated, for example, in FIG. 7. The object to be detected 200 placed on the light-transmitting member 91 is pressed against a member 26 provided between the planar optical sensor 10 and the light-transmitting member 91 by an urging force applied to the light-blocking member 92 by the elastic member 93. In the embodiment, an object placement portion 99 is configured with the light-transmitting member 91, the light-blocking member 92, and the elastic member 93. In other words, the object placement portion 99 includes the light-transmitting member 91 that is a light-transmitting member on which the object to be detected is placed, and the light-blocking member 92 that is a light-blocking member supporting the light-transmitting member from the outer periphery; and the boundary between the light-transmitting member 91 and the light-blocking member 92 has a circular shape, as illustrated as the edge 95 in FIG. 9. The diameter of the circle of the edge 95, that is, the boundary between the light-transmitting member 91 and the light-blocking member 92, is larger than the diameter of the circle of the edge of the dish 210.

The member 26 serves as an optical member that limits the light that is emitted from the light-emitting area LA of the light source panel 20 and reaches the planar optical sensor 10. Specifically, the member 26 includes any one of a plate-shaped louver, a cylindrical opening, and a microlens. The plate-shaped louver has a plurality of plate-like structures arranged in parallel and having plate surfaces along the third direction Dz. The structures are preferably made of a material having a strong light-absorbing property. The member 26 is provided along a plane (Dx-Dy plane) orthogonal to the third direction Dz. The cylindrical opening penetrates the member 26 in the third direction Dz with respect to the base of the member 26. The base is preferably made of a material having a strong light-absorbing property. The microlens is a small lens having an optical axis along the third direction Dz. The base of the member 26 that supports the microlens is preferably made of a material having a strong light-absorbing property. Regardless of what form the member 26 has, the member 26 as the optical member is provided in order to limit the traveling direction of the light emitted from the light sources 22 and reaching the planar optical sensor 10 to the third direction Dz or to a direction having a shallower inclination angle with respect to the third direction Dz.

A housing 90 maintains a configuration in which the light-emitting area LA of the light source panel 20 and the detection area SA of the planar optical sensor 10 face in the third direction Dz. The housing 90 is a light-blocking housing provided so as to accommodate therein in advance the light source panel 20, the elastic member 93, the diffusion plate 25, the light-transmitting member 91, the light-blocking member 92, the member 26, and the planar optical sensor 10. By placing the object to be detected 200 between the member 26 and the light-transmitting member 91, the positional relation among the components illustrated in FIG. 7 is established. In the embodiment, the object to be detected 200 is placed on the light-transmitting member 91 so that the lid 220 side of the object to be detected 200 contacts the light-transmitting member 91. That is, the object to be detected 200 is placed between the planar optical sensor 10 and the light source panel 20 such that the lid 220 is located relatively below and the dish 210 is locates relatively above.

As described above with reference to FIG. 7, the detection device 1 of the embodiment has a structure that allows the object to be detected 200 to be placed so as to be interposed between the planar optical sensor 10 and the light source panel 20. In the placed object to be detected 200, the bottom surface of the dish 210 with the culture medium 215 therein extends along the detection area SA of the planar optical sensor 10 and the light-emitting area LA of the light source panel 20.

The light emitted from the light-emitting area LA of the light source panel 20 is diffused by the diffusion plate 25, passes through the light-transmitting member 91, the object to be detected 200, and the member 26, and reaches the detection area SA of the planar optical sensor 10. Thus, the planar optical sensor 10 can be said to be configured to output data reflecting the intensity of light that has been emitted from the light source 22 and reached the optical sensors WA through the object to be detected 200. The data herein is data based on a set of the outputs from the optical sensors WA, such as an image to be described later. The intensity of the light reaching the detection area SA is affected by the degree of light transmission of the culture medium 215.

FIG. 9 is a schematic plan view illustrating an exemplary case where colonies 222 are formed on the culture medium 215. As illustrated in FIG. 9, when the colonies 222 are formed on the culture medium 215, the degree of transmission of light differs between the portions of the culture medium 215 where the colonies 222 are not present and the portions of the culture medium 215 where the colonies 222 are present. That is, the formation of the colonies 222 causes a change in the degree of light transmission of the culture medium 215. The formation of the colonies 222 is detected based on a difference in the degree of light transmission before and after the change. That is, the colonies 222 formed on the culture medium 215 are detected because the difference in the degree of light transmission before and after the change appears in the result of the detection of light by the detection area SA. In general, the area where the colonies 222 have been formed tends to lower the light transmittance relative to the area of the culture medium 215 where no colonies 222 have been formed, but this description does not rule out the possibility that the opposite may occur.

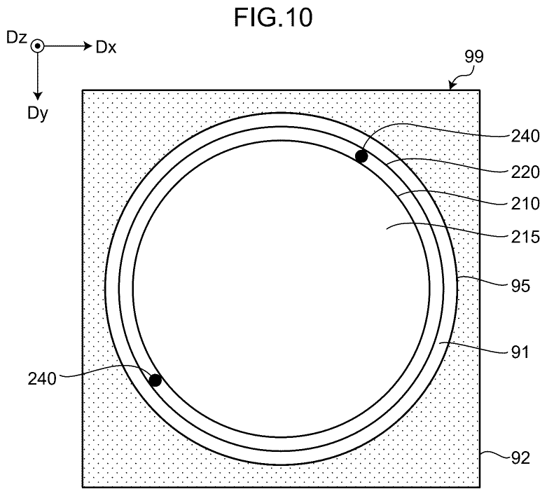

Condensation may occur on the object to be detected 200. Water droplets (for example, water droplets 240 illustrated in FIG. 10) due to such condensation may affect light passing between the planar optical sensor 10 and the light source panel 20.

FIG. 10 is a schematic plan view illustrating an exemplary case where the water droplets 240 are formed on the object to be detected 200. In the embodiment, the object to be detected 200 is placed in the incubator 120 illustrated in FIG. 5, and the image thereof is acquired by the detection device 1. During the image is acquired, the condensation may occur on the object to be detected 200. The water droplets due to the condensation are often formed between the annular outer wall of the dish 210 and the inner wall of the lid 220 as viewed from a planar viewpoint, for example, as illustrated as the water droplets 240 in FIG. 10. That is, the condensation such as the water droplets 240 is likely to occur outside the dish 210.

If a change in the degree of transmission of light (difference in the degree of light transmission before and after the change) is detected in the object to be detected 200 including in portions where the water droplets 240 are formed, then the water droplets 240 may be erroneously determined to be the same things as the colonies 222. That is, the formation of the water droplets 240 may be misidentified as the formation of colonies, even though colonies such as the colonies 222 have not actually been formed.

Therefore, the embodiment is provided with a mechanism to limit the detection of light by the planar optical sensor 10 to the inside of the dish 210. This mechanism can reduce the effect of the water droplets 240 on the results of the detection of light by the planar optical sensor 10. That is, the formation of colonies such as the colonies 222 can be more accurately detected. The following describes the mechanism to limit the detection of light by the planar optical sensor 10 to the inside of the dish 210. Hereinafter, the term simply called “colonies” refers to colonies, such as the colonies 222, of the cultivation targets cultured on the culture medium 215.

To limit the detection of light by the planar optical sensor 10 to the inside of the dish 210, a process is performed to extract the boundary of each of the dish 210, the lid 220, and the light-transmitting member 91 that have been described with reference to FIG. 8. Specifically, a process is performed to use the Hough transform to extract the edge of each of the dish 210, the lid 220, and the light-transmitting member 91 as a circumferential outline.

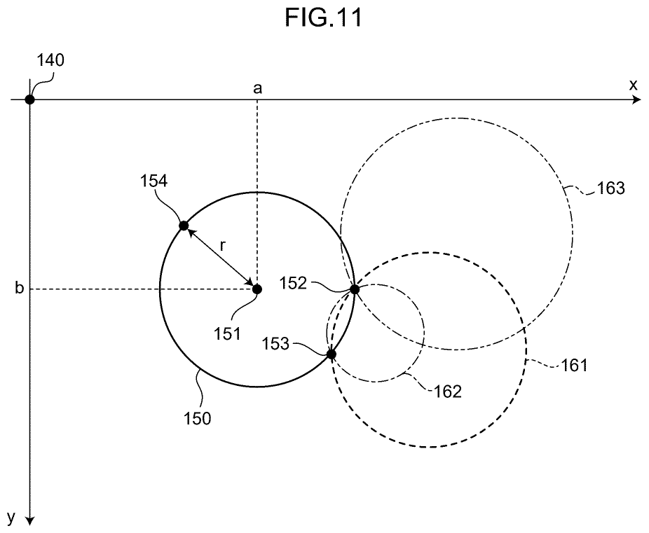

FIG. 11 is a diagram explaining an overview of the Hough transform. The following describes, with reference to FIG. 11, a case in which a circle 150 having a radius r and centered on a point 151 is extracted in a two-dimensional space in an x-y plane with a point 140 serving as an origin. Points 152, 153, and 154 are assumed to be located on the circumference of the circle 150.

The circle having a circumference with which the point 152 coincides is not limited to the circle 150. For example, a countless number of circles such as the circles 161, 162, and 163 can be present, the circumference of each of which coincides with the point 152. Therefore, when attempting to obtain a circle having the circumference with which the point 152 coincides, a countless number of circles are included in the candidates of the target to be obtained. The circumferences of the circles 150, 161, and 162 coincide with the point 153, but the circumference of the circle 163 does not coincide with the point 153. Therefore, by limiting the condition of the circle to be obtained to those having a circumference that coincides with the points 152 and 153, circles such as the circle 163 having a circumference that does not coincide with the point 153, can be excluded from the candidates of the circle to be obtained. In addition, the circumference of the circle 150 coincides with the point 154, but the circumferences of the circles 161 and 162 do not coincide with the point 154. Therefore, by limiting the condition of the circle to be obtained to those having a circumference that coincides with the points 152, 153, and 154, the circle to be obtained can be limited to the circle 150. In other words, the Hough transform extracts the circle 150 as a “more probable circle” that has a circumference passing through a plurality of points (such as the points 152, 153, and 154) through which the circumference of the circle to be obtained passes, with higher priority than other circles such as circles 161, 162, and 163.

The Hough transform used in the embodiment is used to extract a circle having a circumference that coincides with a plurality of points, as described with reference to FIG. 11. Specifically, the Hough transform extracts a circle represented by three values (a, b, r). Of these values, “a” and “b” denote a coordinate in an x direction and a coordinate in a y-direction in an x-y coordinate system with respect to the origin (for example, point 140). That is, the coordinates can be expressed as (x, y)=(a, b). In FIG. 11, the coordinates represented by (x, y)=(a, b) are the coordinates of the point 151. “r” denotes the radius r of the circle centered on the coordinates expressed as (x, y)=(a, b). Any point (x, y)=(X, Y) on the circumference extracted by the Hough transform can be expressed by Expression (1) below.

$${r}^{2} = {( X - a )}^{2} + {( Y - b )}^{2} \qquad ( 1 )$$

The extraction of a plurality of points, such as the points 152, 153, and 154 in FIG. 11, which coincide with the circumference of the circle extracted by the Hough transform is performed using image processing such as an outline extraction process. Specifically, a set of outputs of the optical sensors WA is regarded as an image. The image herein is obtained by regarding an output of one optical sensor WA as one pixel and arranging a plurality of the pixels so as to correspond to the arrangement of the optical sensors WA in the detection area SA. Hereinafter, the term simply called “image” refers to the set of the outputs of the optical sensors WA, unless otherwise noted. The term simply called “pixel” refers to the output of the optical sensor WA, unless otherwise noted. In practice, a process such as an analog-to-digital conversion is performed to regard the output of the optical sensor WA as the pixel. This process is performed by the detection circuit 15 in the embodiment as described above, but may be performed by the control circuit 30.

In the embodiment, the outline extraction process is performed on the image to extract a plurality of outlines. The outlines includes an outline indicating an annular outer peripheral wall of the dish 210, an outline indicating an annular outer peripheral wall of the lid 220, and an outline indicating the edge 95. Each of these outlines includes a plurality of annularly arranged points. When three or more of the points, such as the points 152, 153, and 154 in FIG. 11, are arranged correspondingly to the radius r centered on the point 151, one circle such as the circle 150 can be extracted by the Hough transform. By applying the Hough transform after the outline extraction process, a, b, and r are individually obtained for each of the outlines, and the circumference of the circle represented by the three values a, b, and r is extracted.

In the embodiment, a1, b1, and r1 indicating the circumference corresponding to the outer peripheral wall of the dish 210, a2, b2, and r2 indicating the circumference corresponding to the outer peripheral wall of the lid 220, and a3, b3, and r3 indicating the circumference corresponding to the edge 95 are individually obtained. Each of a1, a2, and a3 indicates the value of “a”. Each of b1, b2, and b3 indicates the value of “b”. Each of r1, r2, and r3 indicates the value of “r”.

In most cases, the multiple points included in an outline that can be regarded as one circle include a significantly larger number of points than three. The outline extraction process is an image binarization process, such as application of a Gaussian filter, but is not limited to this process, and may be any other image processing that can extract an outline included in an image. Additional image processing, such as application of a noise filter, may be further performed between the outline extraction process and the Hough transform to more accurately obtain the outline.

In the embodiment, various extraction processes such as the outline extraction process, the Hough transform, and the additional image processing are performed by the control circuit 30, but the embodiment is not limited to this configuration. For example, dedicated configurations for various extraction processes may be separately provided.

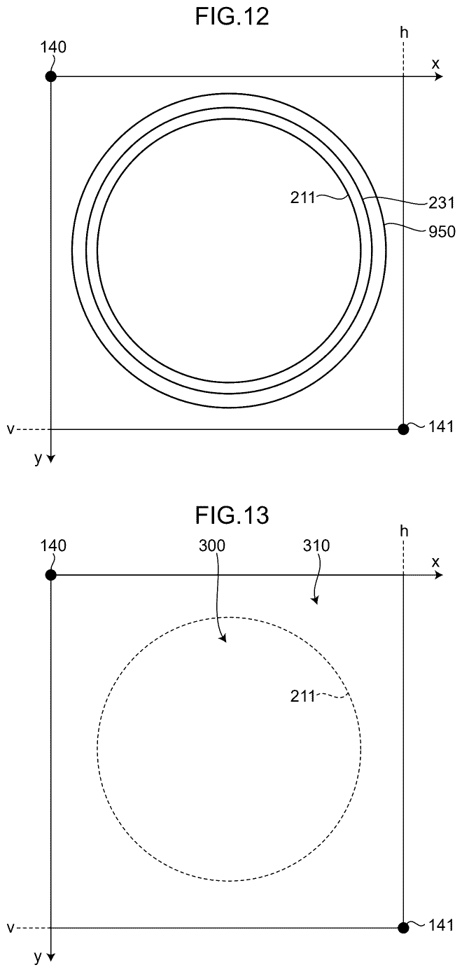

FIG. 12 is a diagram illustrating a plurality of exemplary circumferences obtained by the Hough transform; FIG. 12 illustrates circles 211, 231, and 950 that are three circles obtained in the x-y coordinate system with the point 140 serving as the origin. The circle 211 can be represented by a1, b1, and r1 indicating the circumference corresponding to the outer peripheral wall of the dish 210. The circle 231 can be represented by a2, b2, and r2 indicating the circumference corresponding to the outer peripheral wall of the lid 220. The circle 950 can be represented by a3, b3, and r3 indicating the circumference corresponding to the edge 95.

The point 141 in FIG. 12 and FIG. 13, which is to be described later, is at the coordinates (x, y)=(h, v) expressed by a maximum value h of the x coordinate and a maximum value v of the y coordinate in the x-y coordinate system with the point 140 serving as the origin. One of the points 140 and 141 corresponds to one of the two optical sensors WA located at the diagonal vertices in the rectangular-shaped detection area SA. The other of the points 140 and 141 corresponds to the other of the two optical sensors WA located at the diagonal vertices in the rectangular detection area SA. Thus, the x-y coordinate system illustrated in FIGS. 12 and 13 indicates the location of each of the pixels included in the image as a combination of an x-coordinate value and a y-coordinate value. That is, the output of each of the optical sensors WA can be distinguished by a combination of the x-coordinate value and the y-coordinate value. In other words, the rectangular area where the points 140 and 141 are diagonally arranged in FIGS. 12 and 13 can be said to be an area corresponding to the detection area SA where the optical sensors WA are arranged.

As illustrated in FIG. 12, in the extraction processes including the Hough transform described above, the outer peripheral wall of the dish 210 is extracted as the circle 211 representing a circumferential outline. In the extraction processes, the outer peripheral wall of the lid 220 is extracted as the circle 231 representing a circumferential outline. Furthermore, in the extraction processes, the circle 950 corresponding to the edge 95 is extracted. In the embodiment, the inside of the smallest one of the circumferences obtained by the Hough transform is determined to be the inside of the dish 210. To give a description with reference to FIG. 12, the inside of the circle 211 is determined to be the inside of the dish 210.

FIG. 13 is a diagram illustrating the x-y coordinate system where the inside of the circle 211 is distinguished from the outside thereof. In FIG. 13, a portion of a rectangular area where the points 140 and 141 are diagonally arranged is illustrated as a circle interior 300 and the other portion is illustrated as a circle exterior 310. The circle interior 300 is the inside of the circle 211. The circle exterior 310 is the outside of the circle 211.

In the embodiment, a mask process is performed. The mask process herein is a process to avoid using or producing some outputs of the outputs from the optical sensors WA arranged in the detection area SA. The outputs that are not used or not produced are outputs corresponding to the outputs from the optical sensors WA arranged correspondingly to the circle exterior 310. The mask process uses the circle 211 as a boundary line and excludes the outputs of the optical sensors WA reflected outside the boundary line from each of the images. As described with reference to FIG. 12, the smallest outline (circle) of one or more circumferential outlines (circles 211, 231, and 950) included in the image is used as the boundary line.

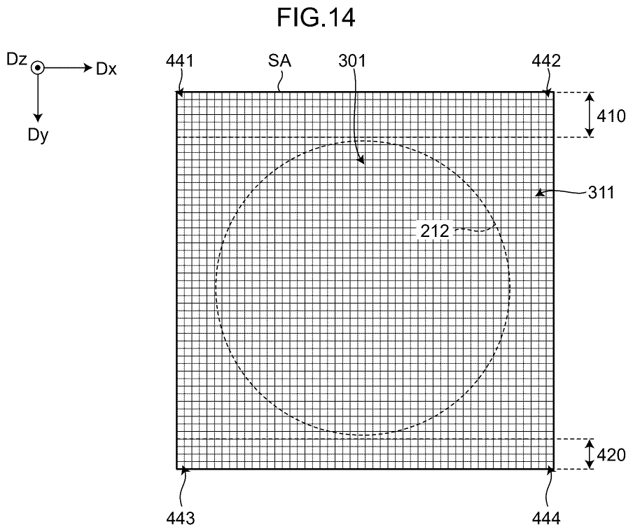

In other words, in the embodiment, the mask process limits the outputs to be used in the process to detect the colonies to the outputs from the optical sensors WA arranged correspondingly to the circle interior 300. This limitation can limit light to be detected by the planar optical sensor 10 to light that has passed through the inside of the dish 210. The following describes details of the mask process in the embodiment with reference to FIG. 14.

FIG. 14 is a schematic diagram illustrating an exemplary application of the mask process to the optical sensors WA arranged in the detection area SA. Each of a plurality of rectangles arranged in a matrix having a row-column configuration along grid lines in the detection area SA illustrated in FIG. 14 schematically represents the optical sensor WA. Optical sensors 441, 442, 443, and 444 in FIG. 14 specially illustrates four of the optical sensors WA arranged at the four corners of the detection area SA. Of these optical sensors, the sensor 441 is the optical sensor WA corresponding to the coordinates of the point 140 illustrated in FIGS. 12 and 13. The optical sensor 444 is the optical sensor WA corresponding to the coordinates of the point 141 illustrated in FIGS. 12 and 13. A circle 212 illustrated in FIG. 14 is a conceptual projection of a circumference corresponding to the circle 211 on the detection area SA. In FIG. 14, the inside and the outside of the circle 212 are distinguished as a circle interior 301 and a circle exterior 311. The circle interior 301 represents the optical sensors WA arranged inside the circle 212 among the optical sensors WA arranged in the detection area SA. The circle exterior 311 represents the optical sensors WA arranged outside the circle 212 among the optical sensors WA arranged in the detection area SA.

The circle interior 301 is determined to be the inside of the dish 210. Therefore, the degree of detection of light indicated by the output of the circle interior 301 is used to detect the formation of the colonies. Specifically, if a dark area, which has not appeared in the temporally previous one of two images obtained at different times, appears in the later one of the two images, the dark area is determined to result from the formation of a colony. The temporally previous one of the two images obtained at different times is, for example, first data, second data, and third data obtained in an initial operation to be described later. The temporally later one of the two images obtained at different times is, for example, the first data, the second data, and the third data obtained in a periodic operation to be described later. The two images obtained at different times are both images that each reflect the output of the circle interior 301.

The circle exterior 311 is considered to be the outside of the dish 210. Therefore, the degree of detection of light indicated by the output of the circle exterior 311 is not used to detect the formation of the colonies. In the embodiment, in a row of the optical sensors WA where all the optical sensors WA arranged along the first direction Dx are located in the circle exterior 311, the optical sensors WA do not operate to produce the output. Hereinafter, the row of the optical sensors WA where all the optical sensors WA arranged along the first direction Dx are located in the circle exterior 311 is referred to as “row of non-operational optical sensors WA”. Specifically, no gate signal is supplied to the scan line 6 shared by the optical sensors WA in the row of non-operational optical sensors WA. No output is transmitted via the signal line 7 from the optical sensor WA coupled to the scan line 6 supplied with no gate signal. Therefore, the detection circuit 15 does not receive the output from the optical sensor WA coupled to the scan line 6 supplied with no gate signal. In FIG. 14, among the rows of the optical sensors WA arranged in the y-direction, rows of the optical sensors WA included in a non-operating area 410 and rows of the optical sensors WA included in a non-operating area 420 correspond to the rows of non-operational optical sensors WA.

In contrast, in a row of the optical sensors WA where one or more of the optical sensors WA arranged along the first direction Dx are located in the circle interior 301, the optical sensors WA operate to produce the output. Hereafter, a row of the optical sensors WA where one or more of the optical sensors WA arranged along the first direction Dx are located in the circle interior 301 is referred to as “row of operational optical sensors WA”. As described above, the degree of detection of light indicated by the output of the circle exterior 311 is not used to detect the formation of the colonies. Thus, in the embodiment, the output of each of the optical sensors WA included in the row of operational optical sensors WA is regarded differently depending on whether the optical sensor WA is located in the circle interior 301 or the circle exterior 311. Specifically, the outputs of the optical sensors WA located in the circle exterior 311, among the optical sensors WA included in the row of operational optical sensors WA, are ignored. In contrast, the outputs of the optical sensors WA located in the circle interior 301, among the optical sensors WA included in the row of operational optical sensors WA, are reflected to the image.

Whether to regard the optical sensors WA lying on the circumference of the circle 212 as being in the circle interior 301 or being in the circle exterior 311 only needs to be determined in advance, and can be changed as appropriate. By regarding the optical sensors WA lying on the circumference of the circle 212 as being in the circle interior 301, colonies that are in contact with or very close to the outer peripheral wall of the dish 210 can be more accurately detected. In contrast, by regarding the optical sensors WA lying on the circumference of the circle 212 as being in the circle exterior 311, even if a dark area appears due to water droplets such as the water droplets 240 formed in contact with the outer peripheral wall of the dish 210 from the outside, misidentification of the dark area as a dark area caused by colonies can be more accurately reduced.

In the embodiment, in order to distinguish the circle interior 301 from the circle exterior 311, the circle 211 that serves as a base of the circle 212 needs to be obtained. Therefore, in a first scan process that is executed first, all rows of the optical sensors WA are regarded as the rows of operational optical sensors WA. That is, in the first scan process, the outputs from all the optical sensors WA are transmitted to the detection circuit 15. The control circuit 30 of the embodiment obtains an image corresponding to the entire detection area SA from the outputs of the optical sensors WA obtained via the detection circuit 15 in the first scan process. The control circuit 30 performs the various types of processes, such as the outline extraction process and the Hough transform described above, on the image to obtain the circle 211. Thus, the control circuit 30 extracts the circumferential outline (circle 211) in the image corresponding to the edge of the dish 210, as the boundary line.

As described with reference to FIG. 4, the light source 22 includes the first light source 22R, the second light source 22G, and the third light source 22B. In the embodiment, the first light source 22R, the second light source 22G, and the third light source 22B are turned on at different times. In the embodiment, the scan process to detect light from the first light source 22R using the optical sensors WA, the scan process to detect light from the third light source 22B using the optical sensors WA, and the scan process to detect light from the second light source 22G using the optical sensors WA are performed individually. The scan process is a process to obtain the image. For example, in the scan process to detect the light from the first light source 22R using the optical sensors WA, the light emitted by the first light source 22R passes through the object to be detected 200 and is detected by the optical sensors WA provided in the detection area SA of the planar optical sensor 10. Processing is performed to regard the outputs of the optical sensors WA produced by this process as the pixels of the image.

The first scan process described above is, for example, a scan process in which the light from the first light source 22R is detected by the optical sensors WA, in the embodiment. The first scan process may be a scan process in which the light from the second light source 22G is detected by the optical sensors WA or a scan process in which the light from the third light source 22B is detected by the optical sensors WA.

If the outer peripheral wall of the dish 210 is thick, the inner and outer peripheral surfaces of the outer peripheral wall may be extracted as individual rings in the outline extraction process and the Hough transform. Even in this case, the inside of the innermost circumference of the circumferences obtained by the Hough transform is regarded as the inside of the dish 210, and thus the description with reference to FIGS. 12 to 14 is applicable to this case.

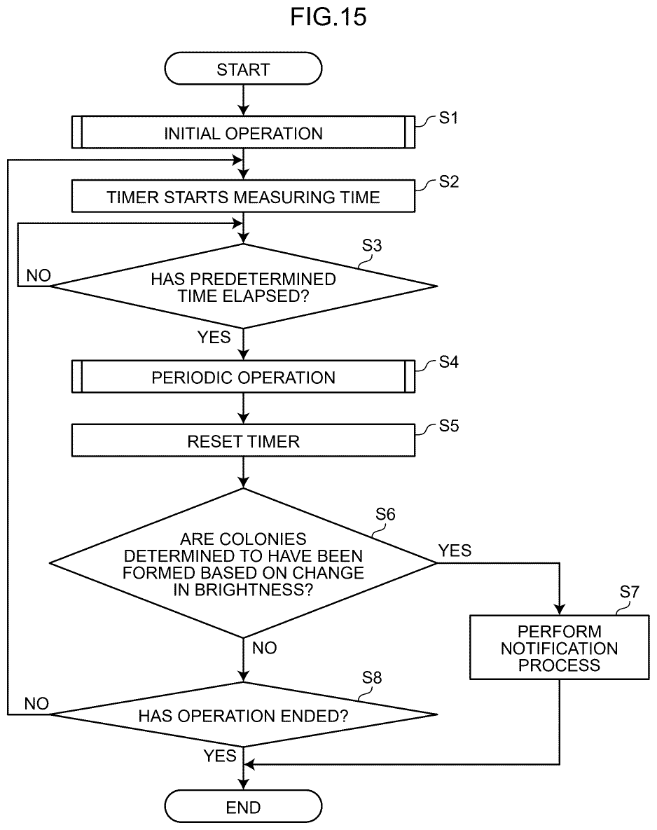

The following describes processing related to the operation of the detection device 1 with reference to flowcharts in FIGS. 15 to 17. Unless otherwise noted, in the embodiment, a process at each step illustrated in the flowcharts in FIGS. 15 to 17 is mainly performed by the control circuit 30.

FIG. 15 is a flowchart of processing related to operations of the detection device 1. First, the initial operation is performed (Step S1). At the time of the initial process, the initial operation is performed immediately after the object to be detected 200 is placed on the detection device 1. That is, at the time of the initial process, no colonies have been formed on the culture medium 215.

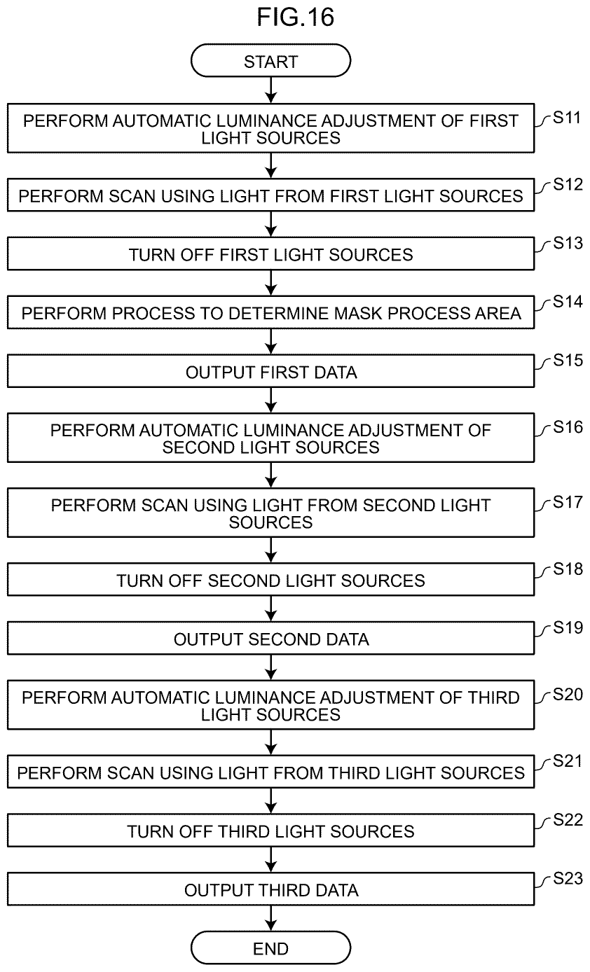

FIG. 16 is a flowchart of the initial process. First, automatic luminance adjustment of the first light sources 22R is performed (Step S11). The automatic luminance adjustment in each of processes at Step S11 and at Steps S16 and S20 to be described later is process to adjust the luminance of a plurality of light sources of the same color provided in the light-emitting area LA to pre-assumed luminance. The following describes an exemplary case in which the automatic luminance adjustment of a plurality of the first light sources 22R is performed in the process at Step S11. In this example, the operation is controlled such that the first light sources 22R start operating at either the lowest luminance or the highest luminance and change in luminance toward the other of the lowest luminance and the highest luminance with the lapse of time. During the passage of the time, the detection of the light using the optical sensors WA provided in the detection area SA and the output from the optical sensors WA are periodically performed. The luminance of the first light sources 22R is regarded as the pre-assumed luminance when the outputs of the optical sensors WA reach outputs corresponding to the pre-assumed luminance.

In the process at Step S11 in the embodiment, the luminance of the first light sources 22R is adjusted individually. Specifically, the optical sensors WA are associated with the first light sources 22R as to which of the first light sources 22R is lit at the pre-assumed luminance at the time when which of the optical sensors WA outputs an output corresponding to the pre-assumed luminance. More specifically, each of the optical sensors WA detects light from the first light source 22R associated with the optical sensor WA more strongly than light from the other first light sources 22R. That is, the first light source 22R and the optical sensor WA associated with each other are arranged so as to overlap or nearly overlap each other as viewed from a planar viewpoint. The luminance of the first light source 22R is determined in this way, thus completing the automatic luminance adjustment.

In the process at each of Step S11 and Steps S16 and S20 to be described later, the control circuit 30 operates the planar optical sensor 10 and the light source panel 20 to perform the automatic luminance adjustment.

The description of a process at Step S16 to be described later is obtained by replacing the first light source 22R in the description of the process at Step S11 with the second light source 22G. The description of a process at Step S20 to be described later is obtained by replacing the first light source 22R in the description of the process at Step S11 with the third light source 22B. The specific process of the automatic luminance adjustment illustrated herein is only an example and is not limited to this example. The details may be changed as appropriate as long as the luminance of the multiple light sources of the same color can be set to the pre-assumed luminance as a result.

After the process at Step S11, the scan process using the light from the first light sources 22R is performed (Step S12). Specifically, the scan process is performed by the control circuit 30 operating the planar optical sensor 10 and the light source panel 20. In the process at Step S12, the light sources turned on by the operation of the light source panel 20 are the first light sources 22R. The second light sources 22G and the third light sources 22B are not turned on in the process at Step S12. As a result, the control circuit 30 obtains an image corresponding to the outputs of the optical sensors WA that have detected the light from the first light sources 22R transmitted through the object to be detected 200. At the completion of the process at Step S12, the first light sources 22R are turned off (Step S13).

In a process at Step S17 to be described later, the light sources to be turned on are not the first light sources 22R, but the second light sources 22G. In a process at Step S21 to be described later, the light sources to be turned on are not the first light sources 22R, but the third light sources 22B.

After the processes at Steps S12 and S13, a process to determine a mask process area is performed (Step S14). Specifically, the control circuit 30 performs the various types of processes, such as the outline extraction process and the Hough transform described above, on the image obtained in the scan process at Step S12. By this processing, circumferences corresponding to outlines of respective configurations, such as the circles 211, 231, and 950 described with reference to FIG. 12, are obtained. The control circuit 30 then sets the outside of the smallest circumference among the obtained circumferences as the mask process area. In the example illustrated in FIG. 13, the mask process area is the circle exterior 311. The control circuit 30 does not use the outputs of the optical sensors WA corresponding to the mask process area for the process to detect the colonies. That is, as described with reference to FIG. 14, the output of the circle exterior 311 is not used for the process to detect the colonies. The process at Step S14 limits the detection of light by the planar optical sensor 10 to the circle interior 301 in which the light transmitted through the inside of the dish 210 is detected. Thus, the process at Step S14 includes the process to extract the circumferential outline (circle 211) in the image corresponding to the edge of the dish 210, as the boundary line.

After the process at Step S14, the first data is output (Step S15). The first data is data of the image obtained using the light from the first light sources 22R and is data of the image that reflects the outputs of the optical sensors WA determined to be in the circle interior 301 (refer to FIG. 14) and does not reflect the outputs of the optical sensors WA determined to be in the circle exterior 311. Specifically, the control circuit 30 regards, as the pixels, the outputs of the optical sensors WA determined to be in the circle interior 301 among the outputs of the optical sensors WA obtained in the process at Step S12. The control circuit 30 sets, as the first data, the data of the image obtained without the outputs of the optical sensors WA determined to be in the circle exterior 311.

After the process at Step S15, the automatic luminance adjustment of the second light sources 22G is performed (Step S16). After the process at Step S16, the scan process using the light from the second light sources 22G is performed (Step S17). Specifically, the scan process is performed by the control circuit 30 operating the planar optical sensor 10 and the light source panel 20. In the process at Step S17, the light sources turned on by the operation of the light source panel 20 are the second light sources 22G. The first light sources 22R and the third light sources 22B are not turned on in the process at Step S17. As a result, the control circuit 30 obtains an image corresponding to the outputs of the optical sensors WA that have detected the light from the second light sources 22G that transmitted through the object to be detected 200. At the completion of the process at Step S17, the second light sources 22G are turned off (Step S18).

After the processes at Steps S17 and S18, the second data is output (Step S19). The second data is data of the image obtained using the light from the second light sources 22G and is data of the image that reflects the outputs of the optical sensors WA determined to be in the circle interior 301 (refer to FIG. 14) and does not reflect the outputs of the optical sensors WA determined to be in the circle exterior 311. Specifically, the control circuit 30 regards, as the pixels, the outputs of the optical sensors WA determined to be in the circle interior 301 among the outputs of the optical sensors WA obtained in the process at Step S17. The control circuit 30 sets, as the second data, the data of the image obtained without the outputs of the optical sensors WA determined to be in the circle exterior 311.

After the process at Step S19, the automatic luminance adjustment of the third light sources 22B is performed (Step S20). After the process at Step S20, the scan process using the light from the third light sources 22B is performed (Step S21). Specifically, the scan process is performed by the control circuit 30 operating the planar optical sensor 10 and the light source panel 20. In the process at Step S21, the light sources turned on by the operation of the light source panel 20 are the third light sources 22B. The first light sources 22R and the second light sources 22G are not turned on in the process at Step S21. As a result, the control circuit 30 obtains an image corresponding to the outputs of the optical sensors WA that have detected the light from the third light sources 22B transmitted through the object to be detected 200. At the completion of the process at Step S21, the third light sources 22B are turned off (Step S22).

After the processes at Steps S21 and S22, the third data is output (Step S23). The third data is data of the image obtained using the light from the third light sources 22B and is data of the image that reflects the outputs of the optical sensors WA determined to be in the circle interior 301 (refer to FIG. 14) and does not reflect the outputs of the optical sensors WA determined to be in the circle exterior 311. The control circuit 30 regards, as the pixels, the outputs of the optical sensors WA determined to be in the circle interior 301 among the outputs of the optical sensors WA obtained in the process at Step S21. The control circuit 30 sets, as the third data, the data of the image that ignores the outputs of the optical sensors WA determined to be in the circle exterior 311.

The initial operation ends with the completion of the process at the first Step S23. As illustrated in FIG. 15, after the initial operation that is the process at Step S1, the timer starts measuring time (Step S2). The process at Step S2 may be performed, for example, by a timer circuit provided in the control circuit 30, by setting a variable that serves as a counter and updating the counter based on an operating clock of the control circuit 30, or by other methods.

After the start of measuring time by the process at Step S2, a check is made to determine whether a predetermined time has elapsed (Step S3). Until the predetermined time elapses, the control circuit 30 waits (No at Step S3), without performing the next process. The predetermined time is five minutes, for example, but is not limited thereto. The predetermined time may be determined as appropriate according to a cycle (time interval) at which determination of the formation of colonies is to be made. When the predetermined time has elapsed after the process at Step S2 (Yes at Step S3), the periodic operation is performed (Step S4).

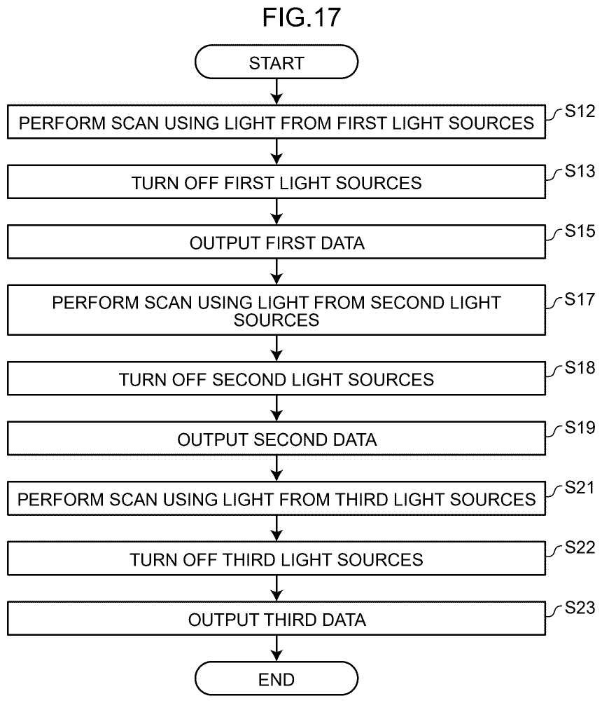

FIG. 17 is a flowchart of the periodic operation. The periodic operation is an operation in which the processes at Steps S11, S14, S16, and S20 are omitted from the processes included in the initial operation described with reference to FIG. 16. In the periodic operation, the processes are performed in the following order: Step S12, Step S13, Step S15, Step S17, Step S18, Step S19, Step S21, Step S22, and Step S23.

The first light sources 22R, the second light sources 22G, and the third light sources 22B are turned on at different times. While one group of a group of the first light sources 22R, a group of the second light sources 22G, and a group of the third light sources 22B is on, the other two groups are not on. These light sources are periodically turned on in the order of the first light sources 22R, the second light sources 22G, and the third light sources 22B. These operations are indicated by the processes at Steps S12, S13, S17, S18, S21, and S22 in the initial operation and the periodic operation.

The luminance of the first light sources 22R that are turned on in the periodic operation is the luminance adjusted by the automatic luminance adjustment by the process at Step S11 in the initial operation. The luminance of the second light sources 22G that are turned on in the periodic operation is the luminance adjusted by the automatic luminance adjustment by the process at Step S16 in the initial operation. The luminance of the third light sources 22B that are turned on in the periodic operation is the luminance adjusted by the automatic luminance adjustment by the process at Step S20 in the initial operation. In the processes at Steps S15, S19, and S23 of the periodic operation, the mask process area determined by the process at Step S14 is applied. That is, the distinction between the circle interior 301 and the circle exterior 311 in the processes at Steps S15, S19, and S23 of the periodic operation reflects the result of the process at Step S14, in the same way as in the initial process.

Therefore, the control circuit 30 can be said to perform the process at Step S14 to extract, as the boundary line, the circle 211 included in the image that has been output in response to the lighting of the first light sources 22R performed first in the initial operation. During the lightings of the second light sources 22G and the third light sources 22B, and during the second and subsequent lightings of the first light sources 22R, the control circuit 30 does not provide the gate signal to specific scan lines 6, as described with reference to FIG. 14. The specific scan lines 6 herein are the scan lines 6 coupled to only the optical sensors WA that produce outputs reflected to the outside of the boundary line in the image. In FIG. 14, the scan lines 6 in the rows of the optical sensors WA included in the non-operating area 410 and in the rows of the optical sensors WA included in the non-operating area 420 correspond to the specific scan lines 6. In the initial operation, the same process as that at Step S14 may be performed on each of the second and the third light sources 22G and 22B.

The periodic operation ends with the completion of the process at Step S23 at the second and subsequent times. As illustrated in FIG. 15, after the periodic operation that is the process at Step S4, the timer is reset (Step S5). That is, the timer that started measuring time at Step S2 is reset in the process at Step S5.

The control circuit 30 determines whether colonies have been formed based on a change in brightness between the data obtained in the initial operation and the data obtained in the periodic operation (Step S6). Specifically, the control circuit 30 compares t-th data obtained in the initial operation with the t-th data obtained in the periodic operation. If a dark area not included in the t-th data obtained in the initial operation is included in the t-th data obtained in the periodic operation, the control circuit 30 determines that the dark area is caused by colonies. The value of “t” in the t-th data is 1, 2, or 3. In a case where t is 1, the control circuit 30 compares the first data obtained in the initial operation with the first data obtained in the periodic operation. If a dark area not included in the first data obtained in the initial operation is included in the first data obtained in the periodic operation, the control circuit 30 determines that the dark area is caused by colonies. The same interpretation can be made also for a case where t=2 or t=3. The control circuit 30 individually performs the determination for each of the case where t=1, the case where t=2, and the case where t=3. The time point at which the size of the dark area has become large enough to be regarded as the colonies is determined in advance and can be changed as appropriate depending on the size of the colonies at which a notification is to be made by a notification process to be described later. The process at Step S6 is not limited to the comparison of the t-data obtained in the initial operation with the t-th data obtained in the regular operation. For example, the t-th data obtained in the latest periodic operation may be compared with the t-th data obtained in the immediately preceding periodic operation, and if the t-th data obtained in the latest periodic operation exhibits a new dark area, the dark area may be determined to result from the formation of a colony.

In the embodiment, if a dark area considered to be a colony appears in one or more of a case where t=1, a case where t=2, and a case where t=3, it is regarded that a colony is determined to have been formed, in the process at Step S6. However, the specific conditions for such determination are not limited to this condition. If a dark area considered to be a colony appears in two or more or all three of the case where t=1, the case where t=2, and the case where t=3, a colony may be determined to have been formed, in the process at Step S6. The process at Step S6 corresponds to the determination process to determine whether a colony is formed, based on a comparison between a plurality of images obtained at different times. In the processes at Steps S15, S19, and S23 described above, the outputs of the optical sensors WA reflected outside the circle 211 serving as the boundary line are excluded from each of the images.

If the process at Step S6 determines that a colony has been formed (Yes at Step S6), the notification process is performed (Step S7). In the notification process, a predetermined notification method is used to perform the notification. In the embodiment, the notification process is performed to send electronic mail indicating the formation of the colony to an electronic mail address of a manager of the object to be detected 200. The electronic mail and the text to be sent via the electronic mail are set in advance. In the embodiment, for example, the control circuit 30 serves as a sender of the electronic mail, but is not limited to this method. As another example, the control circuit 30 may output, to an external information processing device, a signal that serves as an instruction for the external information processing device to send the electronic mail, or may use other methods. The form of the notification performed in the notification process is not limited to the sending of the electronic mail. For example, a voice output device such as a speaker may be operated to output predetermined “voice to notify that a colony has been formed” or other forms of notification may be used.

If the process at Step S6 determines that no colonies have been formed (No at Step S6), the process at Step S2 is re-performed unless the detection device 1 has ended operating (No at Step S8). That is, the timer measures time again, and the periodic operation, the resetting of the timer, and determination of whether a colony has been formed are performed each time the predetermined time elapses. If the detection device 1 has ended operating in the process at Step S8 (Yes at Step S8) or after the process at Step S7 is performed, the processing related to the operations of the detection device 1 ends.

As described above, according to the embodiment, the detection device 1 includes the light sources (light sources 22) that emit light, the planar optical sensor (planar optical sensor 10) on which the optical sensors (optical sensors WA) that detect the light from the light sources are two-dimensionally arranged, the object placement portion (object placement portion 99) provided to allow the object to be detected (object to be detected 200) to be placed such that the object to be detected is interposed between the light sources and the planar optical sensor, and the processor (control circuit 30) that controls operations of the light sources and the planar optical sensor and performs processes based on outputs of the optical sensors. The object to be detected is the culture medium (culture medium 215) that is accommodated in the dish (dish 210) of the container. The planar optical sensor outputs the data reflecting the intensity of light emitted from the light sources and reaching the optical sensors through the object to be detected. The processor performs the extraction process and the determination process. The extraction process is a process to extract the circumferential outline (circle 211) in the data corresponding to the edge of the dish, as the boundary line. The determination process is a process to determine whether a colony has been formed on the culture medium based on the comparison between a plurality of pieces of the data obtained at different times. In the determination process, the outputs of the optical sensors reflected outside the boundary line are excluded from each of the pieces of the data. The boundary line is the smallest of one or more circumferential outlines (circles 211, 231, and 950) included in the data. As a result, the effect of the outputs of the optical sensors reflected outside the boundary line is reduced in the determination process. That is, even if condensation occurs outside the dish, optical effects of water droplets on the data caused by the condensation do not affect the determination process. Therefore, it is possible to reduce false detection of colonies due to confusion between a dark area produced in the data due to the water droplets and a dark areas produced in the data due to the colonies. Thus, according to the embodiment, colonies can be more accurately detected.

In the embodiment, the container further includes the lid (lid 220). The lid has the cylindrical outer circumferential wall that covers the cylindrical outer circumferential wall of the dish (dish 210) from the outside. The extraction process performed by the processor (control circuit 30) includes the Hough transform. The extraction process extracts the outer peripheral wall of each of the dish and the lid as the circumferential outline. The boundary line is the smallest of one or more circumferential outlines included in the data. With these configurations, the optical effects of the water droplets on the data caused by the condensation occurring outside the dish do not affect the determination process, even with the configuration of the object to be detected from which the multiple circumferential outlines are extracted. Thus, the colonies can be more accurately detected.

In the embodiment, the object placement portion (object placement portion 99) includes the light-transmitting member (light-transmitting member 91) on which the object to be detected is placed and the light-blocking member (light-blocking member 92) that supports the light-transmitting member from the outer periphery. Therefore, even if optical changes occur due to temporal changes or the like outside the light-blocking member, the influence of the optical changes on the output of the planar optical sensor can be reduced. That is, it is possible to reduce false detection of colonies due to the optical changes that have occurred outside the light-blocking member.

In the embodiment, the diameter of the circle of the boundary between the light-transmitting member (light-transmitting member 91) and the light-blocking member (light-blocking member 92) is larger than the diameter of the circle of the edge of the dish (dish 210). Therefore, the influence of the light-blocking member (light-blocking member 92) on the light passing through the dish can be reduced.

In the planar optical sensor (planar optical sensor 10) in the embodiment, the optical sensors are coupled to the scan lines (scan lines 6) and the signal lines (signal lines 7) that are arranged in a matrix having a row-column configuration. The scan lines are provided along the first direction (first direction Dx) and transmit the gate signals that cause the optical sensors (optical sensors WA) to generate the outputs. The signal lines are provided along the second direction (second direction Dy) orthogonal to the first direction and transmit the outputs of the optical sensors. The light sources (light sources 22) in the embodiment include first light sources (first light sources 22R) that emit light in a first color, the second light sources (second light sources 22G) that emit light in a second color, and the third light sources (third light sources 22B) that emit light in a third color. In the embodiment, the first light sources, the second light sources, and the third light sources are turned on at different times, and, while one group of the group of the first light sources, the group of the second light sources, and the group of the third light sources is on, the other two groups are not on. The first light sources, the second light sources, and the third light sources are periodically turned on in this order. The processor (control circuit 30) extracts the boundary line included in the data output in response to the lighting of the first light sources performed first. During lightings of the second light sources and the third light sources, and during second and subsequent lightings of the first light sources, the gate signal is not provided to the scan lines coupled to only the optical sensors that produce outputs reflected to the outside of the boundary line of the data. As a result, the circumferential outline (circle 211) in the data corresponding to the edge of the dish (dish 210), can be extracted as the boundary line with minimum processing, and the boundary line can be shared in subsequent processing on the data. Since the gate signal is not provided to the scan lines coupled to only the optical sensors that produce outputs reflected to the outside of the boundary line, the data can be smaller than when the gate signals are provided to all scan lines. Therefore, the processing load of the image processing related to the determination process can be further reduced. Since some of the scan lines are not provided with the gate signals, time required to output the data can be reduced compared with the case where all the scan lines are provided with the gate signals. Since some of the scan lines are not provided with the gate signals, power consumption can also be reduced compared with the case where all the scan lines are provided with the gate signals.

In the embodiment, the light in the first color emitted by the first light sources (first light sources 22R) is red light; the light in the second color emitted by the second light sources (second light sources 22G) is green light; and the light in the third color emitted by the third light sources (third light sources 22B) is blue light. As a result, data corresponding to three light colors constituting data of what is called a red-green-blue (RGB) image is obtained. Therefore, optical effects produced by the colonies on the culture medium can be acquired more reliably.

Furthermore, as illustrated in FIG. 7, the object to be detected 200 is placed on the light-transmitting member 91 in the state where the dish 210 with the culture medium 215 therein is located in the upper position relative to the lid 220 and the lid 220 is located in the lower position relative to the dish 210. Therefore, the upward movement and condensation of moisture evaporated from the culture medium 215 can be suppressed. The drying of the culture medium 215 can be inhibited, and better imaging and the like of the culture medium 215 can be achieved.

In the embodiment, the light sources 22 including the first light sources 22R, the second light sources 22G, and the third light sources 22B are employed as light sources, but the light sources that can be employed in the embodiment according to the present disclosure are not limited to such light sources. For example, light sources corresponding to light in four or more colors of light may be employed, or light sources corresponding to one or two colors of light may be employed. Light in combined colors may also be used by simultaneously turning on some or all of a plurality of types of light sources that emit light in different colors. For example, when the first light sources 22R, the second light sources 22G, and the third light sources 22B are simultaneously turned on, white light is obtained.

The relative positional relation in the up-and-down direction between the planar optical sensor 10 and the light source panel 20 is not limited to the example illustrated in FIG. 7, and may be opposite to the relation illustrated in FIG. 7. The elastic member 93 is not essential to the object placement portion 99. For example, the light-blocking member 92 may be fixed to the housing 90 so that the light-transmitting member 91 is interposed between the planar optical sensor 10 and the light source panel 20. In this case, a gap allowing the object to be detected 200 to be inserted therein is provided above the light-transmitting member 91, between the light-transmitting member 91 and the planar optical sensor 10 or the light source panel 20.

Although the lid 220 is not essential in the object to be detected 200, the lid 220 is more preferably provided in order to reduce foreign matter entering the culture medium 215. The dish 210 of the embodiment is the Petri dish, but is not limited thereto, and may be another component that functions in the same way as the Petri dish.

Other operational advantages accruing from the aspects described in the present embodiment that are obvious from the description herein, or that are conceivable as appropriate by those skilled in the art will naturally be understood as accruing from the present disclosure.

What is claimed is:

1. A detection device comprising:
a light source configured to emit light;
a planar optical sensor in which a plurality of optical sensors configured to detect the light from the light source are two-dimensionally arranged;
an object placement portion provided to allow an object to be detected to be placed such that the object to be detected is interposed between the light source and the planar optical sensor; and
a processor configured to control operations of the light source and the planar optical sensor and perform processes based on outputs of the optical sensors, wherein
the object to be detected is a culture medium accommodated in a dish of a container,
the planar optical sensor is configured to output data reflecting an intensity of light emitted from the light source and reaching the optical sensors through the object to be detected,
the processor is configured to perform:
an extraction process to extract a circumferential outline in the data corresponding to an edge of the dish, as a boundary line; and
a determination process to determine whether a colony has been formed on the culture medium based on a comparison between a plurality of pieces of the data obtained at different times, and
in the determination process, outputs of the optical sensors reflected outside the boundary line are excluded from each of the pieces of the data.

2. The detection device according to claim 1, wherein
the container further comprises a lid,
the lid has a cylindrical outer circumferential wall that covers a cylindrical outer circumferential wall of the dish externally,
the extraction process includes the Hough transform,
the extraction process extracts the outer circumferential wall of each of the dish and the lid as a circumferential outline, and
the boundary line is the smallest of one or more circumferential outlines included in the data.

3. The detection device according to claim 1, wherein
the object placement portion comprises:
a light-transmitting member on which the object to be detected is to be placed; and
a light-blocking member that supports the light-transmitting member from an outer periphery, and
a boundary between the light-transmitting member and the light-blocking member is circular.

4. The detection device according to claim 3, wherein a diameter of a circle of the boundary is larger than a diameter of a circle of the edge of the dish.

5. The detection device according to claim 1, wherein
in the planar optical sensor, the optical sensors are coupled to scan lines and signal lines that are arranged in a matrix having a row-column configuration, the scan lines being provided along a first direction and configured to transmit gate signals that cause the optical sensors to generate outputs, and the signal lines being provided along a second direction orthogonal to the first direction and configured to transmit the outputs of the optical sensors,
the light source comprises:
a first light source configured to emit light in a first color;
a second light source configured to emit light in a second color; and
a third light source configured to emit light in a third color,
the first light source, the second light source, and the third light source are configured to be turned on at different times from one another,
while one of the first light source, the second light source, and the third light source is on, the other two light sources are not on,
the first light source, the second light source, and the third light source are configured to be periodically turned on in the order as listed,
the processor is configured to extract the boundary line included in the data output in response to lighting of the first light source performed first, and
during lightings of the second light source and the third light source and during second and subsequent lightings of the first light source, the gate signal is not provided to the scan lines coupled to only the optical sensors configured to produce outputs reflected to the outside of the boundary line of the data.

6. The detection device according to claim 5, wherein
the light in the first color is red light,
the light in the second color is green light, and
the light in the third color is blue light.
